(19) United States
(12) Patent Application Publication
(10) Pub. No.: US 2015/0252795 A1
(43) Pub. Date: Sep. 10, 2015

(54) Electrostatic Thruster

(71) Applicant: Michael Junior Spruill, Washington, NC (US)

(72) Inventor: Michael Junior Spruill, Washington, NC (US)

(21) Appl. No.: 14/722,304

(22) Filed: May 27, 2015

(51) Int. Cl. F03H 1/00

(52) U.S. Cl. CPC F03H 1/0037

(57) ABSTRACT

The electrostatic thruster is an electrostatic propulsion device which produces a force by making the grounded conductors and the charged conductor composing the device experience a stronger electric field on one side of the device than the other side. This is done by surrounding each half of the inner conductor with its own dielectric of each dielectric's own unique permittivity and placing a grounded conductor above and below the inner conductor-double dielectric assembly. The dielectric with the higher permittivity will produce a weaker electric field on its half than the dielectric with the lower permittivity causing a non-zero net electrostatic force to move in the direction of the dielectric with the lower permittivity when the charged conductor is electrically powered.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Capacitance is the electric charge that is added to an isolated conducting body per unit increase in the body's electrical voltage. Capacitance is measured in coulomb per volt (C/V) or Farad (F). A capacitor consists of two conductors separated by free space or any other dielectric medium A capacitor can consist of conductors of any shape. Capacitance is a physical property of a two-conductor system and depends on the geometry of the conductors and the permittivity of the medium between them. The energy stored when bringing together two charges is potential energy. Work is done by providing an electrical voltage difference between two conductors in a capacitor. In a system of conducting bodies with fixed potentials, a non-zero force occurs when the stored energy in the capacitor displaces the capacitor by a distance, L, when the voltage difference is held constant. In most capacitors, there is a zero net force due to the fact that the capacitor is symmetrical about the axis perpendicular to the direction of the electrical voltage difference which makes the forces experienced on the capacitor's inner conductors both equal and opposite.

Dielectric materials are essentially insulators, which means no current will flow through the given dielectric when a voltage is applied but, unlike insulators, dielectrics are polarized when a voltage is applied. This means dielectrics can store electrical energy from an electrical field produced by an electrical voltage. The magnitude of the stored electrical energy is determined by the dielectric constant or permittivity. The permittivity represents the ability of a material to store electrical energy in the presence of an electrical field.

There is a limit on the voltage insulators and dielectrics can withstand before conducting electricity. This is called the breakdown voltage. For example, air is considered an insulator but under certain circumstances, air can conduct electricity as in a lightning strike. In this case, air is said to be ionized and produces an electrical current. The breakdown voltage per unit length is called the dielectric strength of a material. Once a material is above its dielectric strength, that material will ionize. Air's dielectric strength is 3 e10⁶ Volts/meter.

The aforementioned discussion is a major factor in electrostatic propulsion devices. A type of electrostatic propulsion device named the Frolov capacitor is an asymmetrical capacitor which is T-shaped. Invented by Alexander V. Frolov, the capacitor provides lift because the conductors in the capacitor are co-linear and separated by a distance, W. When a voltage difference is supplied to the conductors, the conductors attract and, with one parallel side of the co-linear conductors being closer on one side than the other, the conductors attract more on one side than the other, making movement to one of the sides possible.

### BRIEF SUMMARY OF THE INVENTION

The electrostatic thruster is an electrostatic propulsion device which produces a force by making the grounded conductors and the charged conductor composing the device experience a stronger electric field on one side of the device than the other side. This is done by surrounding each half of the inner conductor with its own dielectric of each's own unique permittivity and placing a grounded conductor above and below the inner conductor-double dielectric assembly. The dielectric with the higher permittivity will produce a weaker electric field on its half than the dielectric with the lower permittivity causing a non-zero net electrostatic force to move in the direction of the dielectric with the lower permittivity when the charged conductor is electrically powered.

The electrostatic thruster will find its purpose in aerial, terrestrial, underwater, marine and space vehicles as their primary propulsion system. Because it needs no gears, transmission or drive shaft, considerable weight is eliminated and no lubricants are needed.

### BRIEF DESCRIPTION OF THE SEVERAL VIEWS OF THE DRAWINGS

FIG. 1 depicts the plan view of the preferred embodiment of the electrostatic thruster.

FIG. 2 depicts the elevation view of the preferred embodiment of the electrostatic thruster and its direction of force.

FIG. 3 depicts the plan view of the inner conductor of the preferred embodiment of the electrostatic thruster.

FIG. 4 depicts the elevation view of the inner conductor of the preferred embodiment of the electrostatic thruster.

FIG. 5 depicts the plan view of a dielectric half of the preferred embodiment of the electrostatic thruster.

FIG. 6 depicts the elevation view of a dielectric half of the preferred embodiment of the electrostatic thruster.

FIG. 7 depicts the plan view of the grounded conductor of the preferred embodiment of the electrostatic thruster.

FIG. 8 depicts the elevation view of the grounded conductor of the preferred embodiment of the electrostatic thruster.

FIG. 9 depicts the plan view of a second embodiment of the electrostatic thruster.

FIG. 10 depicts the plan view of a third embodiment of the electrostatic thruster.

FIG. 11 depicts the plan view of a fourth embodiment of the electrostatic thruster.

FIG. 12 depicts a schematic representation of the electrical circuit in which includes the electrostatic thruster.

In the drawings, FIGS. 1-12 depict various aspects of the electrostatic thruster where numbers 1 through 12 represent a different feature of the device. Number 1 is the inner conductor. Number 2 is the weak dielectric half. Number 3 is the strong dielectric half. Number 4 is the inner conductor pocket. Number 5 is the dielectric tabbed power entry. Number 6 is the grounded conductor half. Number 7 is the threaded grounded power terminal. Number 8 is the electrostatic force. Number 9 is the schematic representation of the electrical ground. Number 10 is the schematic representation of a variable resistor. Number 11 is the schematic representation of an electrical voltage source. Number 12 is the schematic representation of the electrostatic thruster.

### DETAILED DESCRIPTION OF THE INVENTION

Electric field intensity is the force (8) acting on a unit test charge. Therefore, in moving a unit charge from a first point to a second point in an electric field, work must be done against the field. The electric potential energy per unit charge between the second point and the first point is the electric potential. The electrostatic voltage is the potential difference (V₂−V₁) between the second point and the first point. Going against the electric field, E, the electric potential, V, increases. The electric field is directed from positive to negative charges, while the electric potential increases in the opposite direction.

Work is done by the field (and not against the field) between negative charges and positive charges. This is due to the fact that opposite charges attract in nature, so no other external work is needed.

In a system of conducting bodies with fixed potentials where dielectrics, which are also known as insulators, may also be present, a displacement by a conducting body would result in a change in total electrostatic energy and would require the voltage sources connected to the conducting bodies to transfer charges to the conductors in order to keep them at their fixed potentials. Noting that the volume, v′, is equal to A_{C}*L_{E}, the energy supplied to the system by two conducting bodies is W_{E}=½∫_{v′}p_{v′}Vdv′=½p_{v′}V_{v′} where W_{E} is the electrical energy supplied to the system, dv′ is the differential volume of the highest charged conducting body, v′ is the volume of the highest charged conducting body, A_{C} is the area of the conductor's face, L_{E} is the length of the conductor's sides, V is the electric potential between two conducting bodies and p_{v′} is the charge density of the charged conducting body. When at least one of the conducting bodies moves a distance, L_{M}, mechanical work is done by the system. The mechanical work done by the system as a consequence of a displacement, L_{M}, is W_{M}=F_{E}L_{M} where W_{M} is the mechanical work done, F_{E} is the electrostatic force (8) produced by a conducting body and L_{M} is the distance moved by a conducting body. As is the case in a frictionless, conservative system, the work supplied to the system must equal the work done by the system, therefore, denoting the mechanical displacement, L_{M}, as being equal to the distance between the conducting bodies, the electrostatic force (8), F_{E}, is solved in the following equation: F_{E}=W_{M}/L_{M}=½*p_{v′}Vv′/L_{M}.

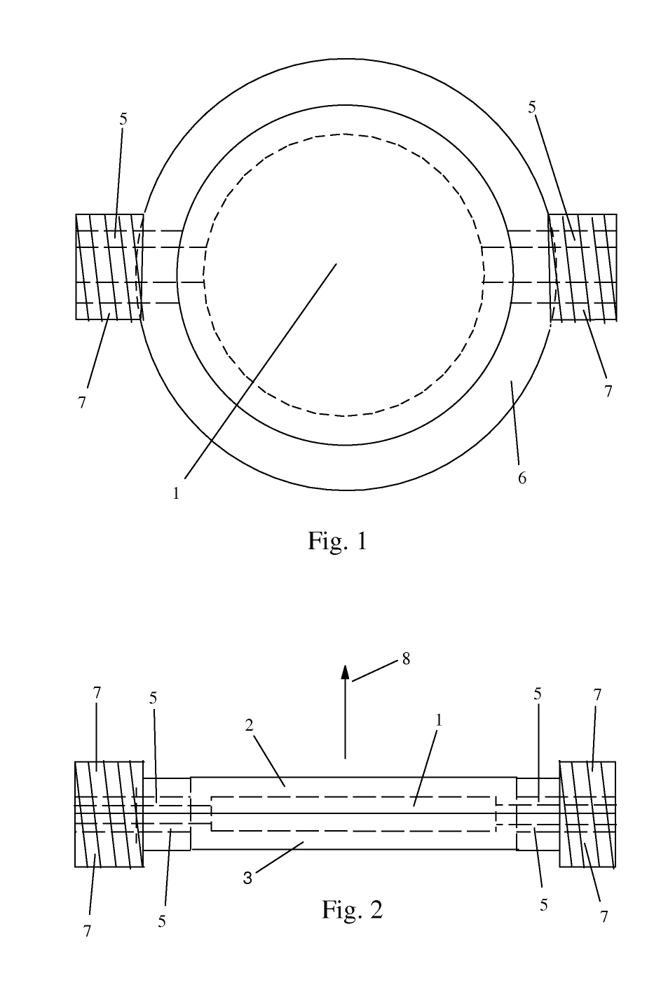

The electrostatic thruster, as shown in FIG. 1 and FIG. 2, works by causing the electrostatic force due to attraction between a charged conductor and a grounded conductor on one half of the device to be more than the force between the same charged conductor and the same grounded conductor on the remaining half.

This is accomplished by, first, having a first dielectric of a certain relative permittivity encasing one half of a charged conductor on all of that half's sides and a second dielectric with a lower relative permittivity encasing the other half of the same charged conductor. Second, to enable movement, two grounded conductors are placed co-linearly with the charged conductor where the three conductors are arranged in such a manner as one of the grounded conductors is above the charged conductor and the second of the two grounded conductors is below the charged conductor. This must be done, otherwise, the conductors would move against each other, thereby, negating their forces causing a net zero force and, therefore, producing no movement.

The job of the dielectrics is to cause the electric field between the grounded conductors and the charged conductor to be at different magnitudes. The higher the relative permittivity of the dielectric, the lower the electrostatic force of attraction between the conductors. The lower the relative permittivity of the dielectric, the larger the electrostatic force of attraction between the conductors. This is due to the fact that a higher permittivity dielectric will store more energy in the electric field which becomes potential energy instead of kinetic energy. This kinetic energy becomes the electrostatic force. A lower permittivity dielectric will have less potential energy but more kinetic energy to be used as the electrostatic force. When a dielectric of higher permittivity is placed on side of a charged conductor and a dielectric of lower permittivity is placed on the other side of the same charged conductor, a tug-of-war on the grounded conductors ensues by the two sides of the charged conductor. The side with the lower permittivity will pull with the highest force, thereby pulling the device to its side with a net force (8) that is the difference of the forces determined by the two dielectrics.

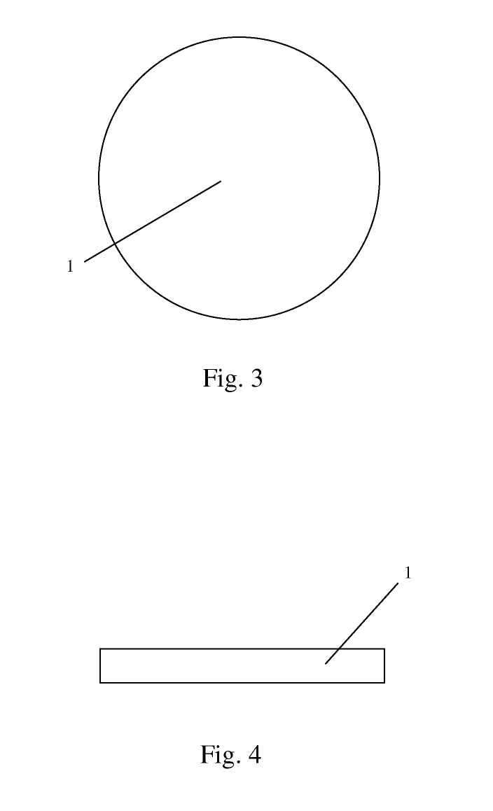

The electrostatic thruster comprises at least four parts. The first of those is the inner conductor (1). The preferred shape of the inner conductor (1) is shown in FIG. 3 and FIG. 4. There is one inner conductor (1) in the preferred embodiment of the electrostatic thruster. The inner conductor's (1) faces can be of any shape but it consists of a material that is electrically conductive. The inner conductor's (1) purpose is to move the device by attracting to the grounded conductor above it and the grounded conductor below it.

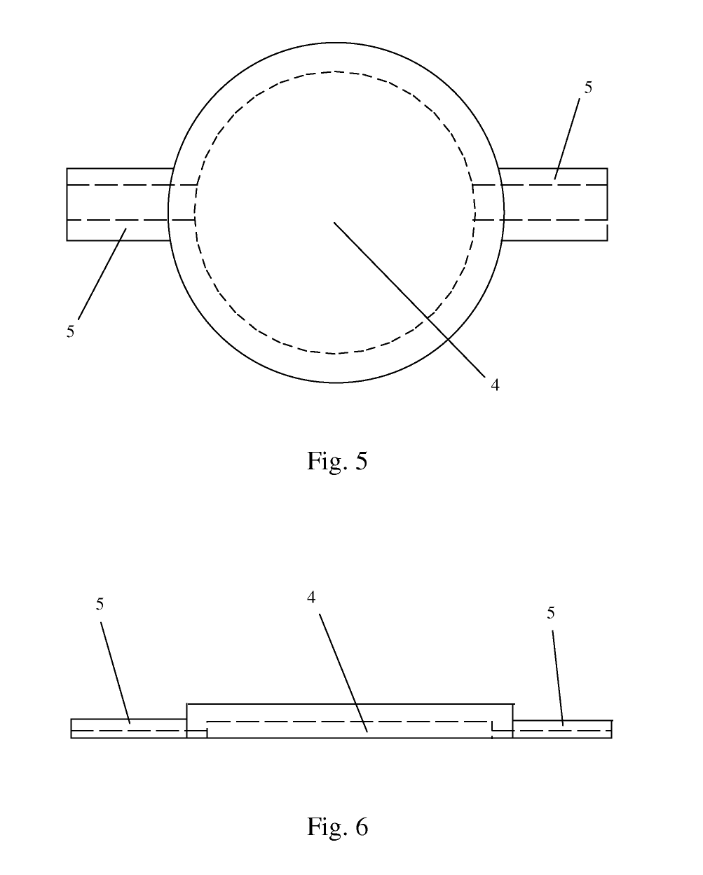

The second part is the weak dielectric (2). The preferred shape of the weak dielectric (2) is shown in FIG. 5 and FIG. 6. There is one weak dielectric (2) in the preferred embodiment of the device. The weak dielectric (2) is the dielectric with the lower permittivity. Its job is to cause a larger magnitude electric field than the strong dielectric. The force will move in the direction of the weak dielectric (2). The weak dielectric's (2) face must be of the same shape as the inner conductor (1) but with a lip or overhang around its edges as to hold half the width of the inner conductor (1). This lip or overhang forms a place of safety for the inner conductor (1) called the inner conductor pocket (4). Of course, the weak dielectric (2) must be a dielectric and it must enclose one-half of the volume of the inner conductor (1).

The third part is the strong dielectric (3). The preferred shape of the strong dielectric (3) is shown in FIG. 5 and FIG. 6. There is one strong dielectric (3) in the preferred embodiment of the device. The strong dielectric (3) is the dielectric with the higher permittivity. Its job is to cause a smaller magnitude electric field than the weak dielectric (2). The force will move away from the strong dielectric (3). The strong dielectric's (3) face must be of the same shape as the inner conductor (1) but with a lip or overhang around its edges as to hold half the width of the inner conductor (1). This lip or overhang forms a place of safety for the inner conductor (1) called the inner conductor pocket (4). Of course, the strong dielectric (3) must be a dielectric and it must enclose one-half of the volume of the inner conductor (1).

Both the weak dielectric (2) and the strong dielectric (3) will have one semicircular tabbed opening at each opposite end of their edges named the dielectric tabbed power entry (5). The dielectric tabbed power entry (5) will guide the inner wire of an outside powered coaxial cable to the inner conductor (1) in order for the inner conductor (1) to be electrically charged. The dielectric tabbed power entry (5) extends to inside the threaded grounded power terminal (7) in order to protect the inner wire of the outside power coaxial cable from the environment and to prevent the inner wire from contacting to ground.

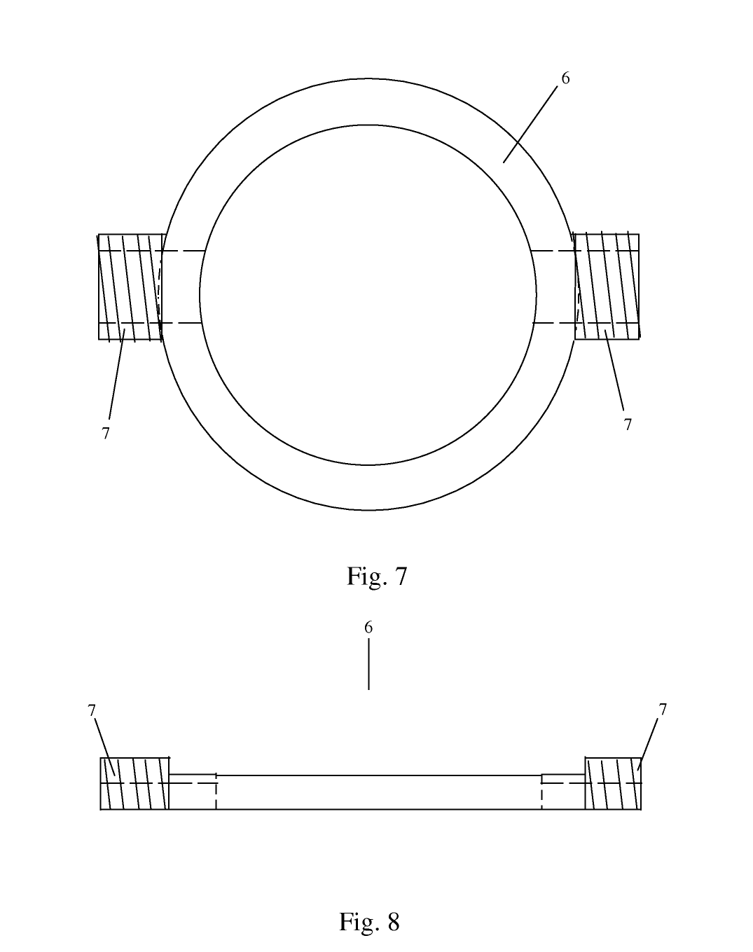

The fourth part of the electrostatic thruster is the grounded conductor half (6). The shape of the preferred grounded conductor half (6) is shown in FIG. 7 and FIG. 8. In the preferred embodiment there are two four grounded conductor halves (6) as two grounded conductor halves (6) produce two whole grounded conductors. The grounded conductor halves (6), once whole, aid the inner conductor (1) to move the device forward. The grounded conductor also holds the electrostatic thruster in one piece when the two grounded conductor halves (6) are joined together by screwing two outside coaxial cables to the threaded grounded power terminals (7) on both ends of the joined grounded conductor halves (6). The grounded conductor halves (6) are made of an electrically conductive material and is always meant to be grounded or, in other words, always meant to be at an electrical voltage potential of zero volts. Also, the grounded conductor halves (6) are meant to be a perimeter in the shape of the edges of the faces of the dielectric halves (2, 3). This is done in order to fit the grounded conductor halves (6) flush to the dielectric halves (2, 3) without any air gaps. In other embodiments, the grounded conductor halves (6) may be joined or attached together by other means besides the threaded end of a coaxial cable.

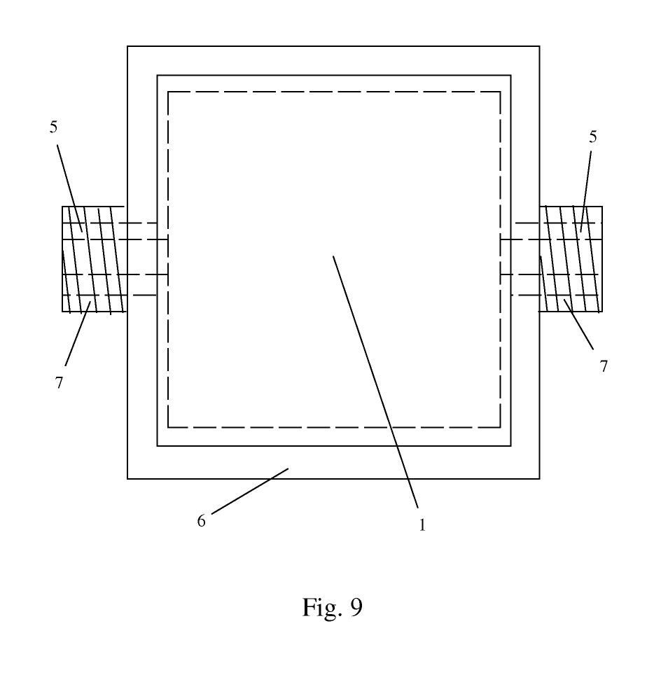

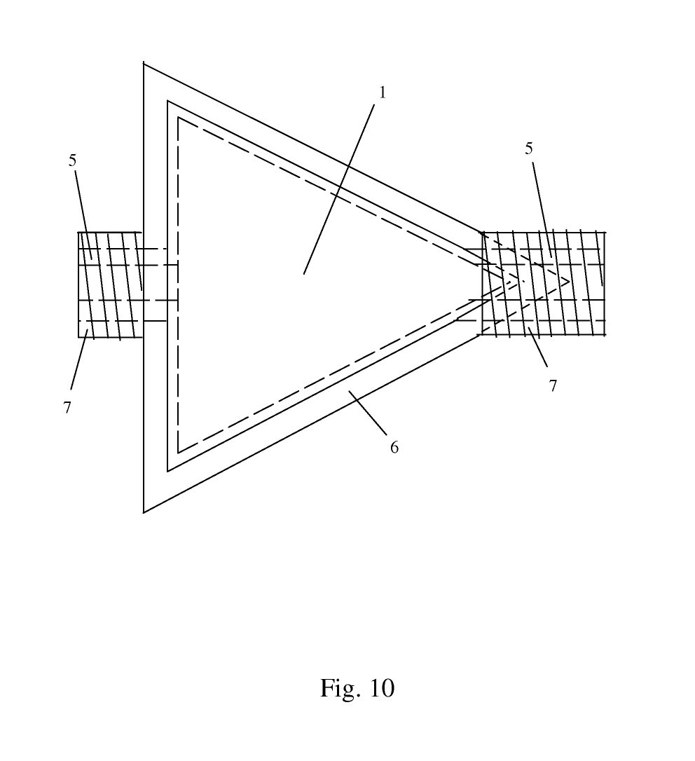

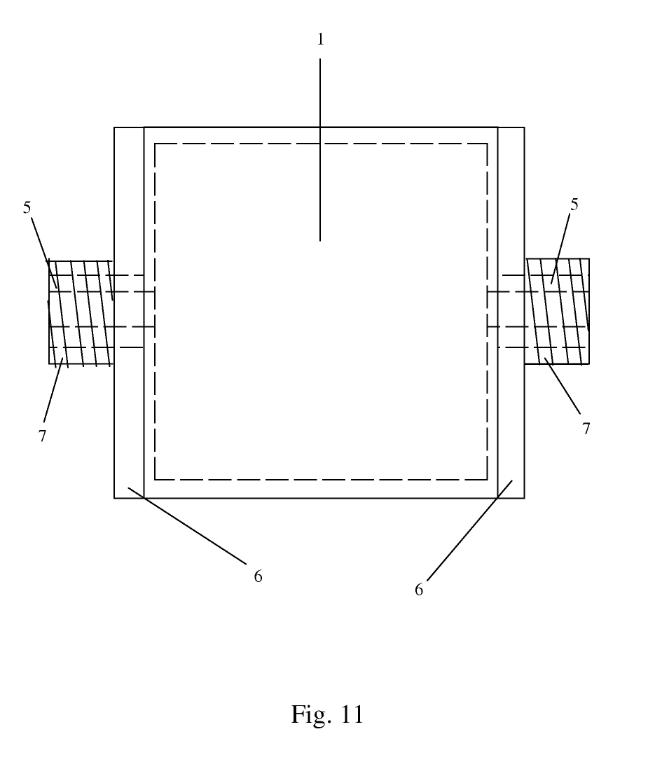

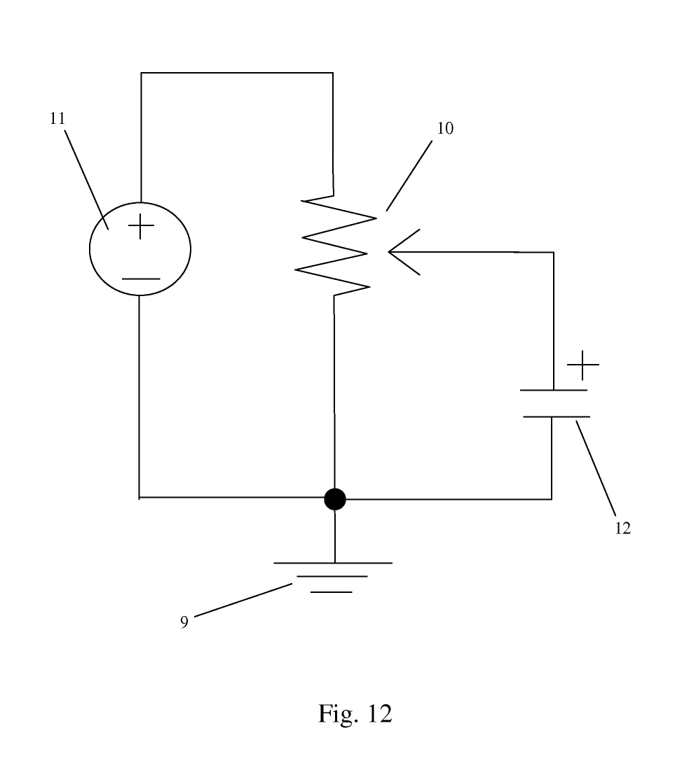

Speaking of the embodiments, the preferred embodiment will have a level circular face. The level circular face is the preferred embodiment due to the arguable fact that it is the most efficient use of space. The other embodiments of the electrostatic thruster will have different polygonal faces ranging from a triangle to any n-sided polygon. Also in some embodiments, the entire perimeter may not be framed by the grounded conductor. As long as two opposite sides are framed by the grounded conductor, there will be an electrostatic force (8), although the magnitude of this force (8) may not be greater than that of an electrostatic thruster with its entire perimeter framed by the grounded conductor. These embodiments may be placed side-by-side in a continuous manner on their unframed sides. Also, other embodiments may have dielectric halves (2, 3) of dissimilar depths or thicknesses. One last difference in embodiments may be in topologies. At least one face may not be level or flat. Examples of other embodiments besides a triangular faced device, as shown in FIG. 10, include a rectangular faced device, as shown in FIG. 9, and a rectangular faced device with only two opposite sides framed by the grounded conductors as shown in FIG. 11.

The following is a design example detailing the calculations in building electrostatic thrusters. Due to unaccounted real world conditions, the exact performance may vary.

First, discover the initial conditions the device will be under.

Given: A 730-kg (1613-lb) vehicle must accelerate from 0 to 27 m/s in 30 seconds (0 to 60 mi/hr in 30 seconds). Using a maximum battery source of 7.2 kiloWatt-hours (kWh) and neglecting friction and air resistance, design an electrostatic thruster able to move the vehicle under these conditions.

Mass of the vehicle=Mv=730 kg

Acceleration of the vehicle=Av=(27 m/s)/(30 s)=0.900 m/s²

Battery source of the vehicle=Uv=7.2 kWh

Permittivity of free space=∈o=[1/(36*JI)]e-9 Farads/meter (F/m)

Number of electrostatic thrusters=I=1

Second, calculate the maximum force for each electrostatic thruster.

Force of the vehicle=Fv=Mv*Av=(730 kg)*(0.900 m/s²)=657 Newtons (N)

Force used by each device=Fe=Fv/I=657 N/1=657 N (This is important. The more electrostatic thrusters attached to an object, the less force that is needed by each electrostatic thruster to move the object.)

Next, decide the limitations to be placed on the electrostatic thrusters.

The faces of the electrostatic thrusters will be circular. (This is important. The shape of the faces is the shape of the inner conductor and this shape will determine area which, in turn, is a determining factor in the magnitude of energy and force produced by a given voltage applied to the device.) Minimum time to discharge and charge the electrostatic thrusters (for braking, accelerating and decelerating) is τ_{V}=1 second.
The maximum voltage to be applied to the inner conductor is V_{MAX}=600 Volts.
The width of the inner conductor is W_{C}=8.128 e-4 meters (m)=0.032 in.
The height of each of the two grounded conductors=H_{G}=2.54 e-2 m=1.00 in. The height of each grounded conductor is just the difference between each grounded conductor's inner and outer radii.

Next, calculate the thickness of the dielectric halves surrounding the faces and edges of the inner conductor. This step must take into consideration the dielectric strength value of air which is 3 e10⁶ V/m because air ionizes above this value. For this step, the thickness will have a minimum using this value.

Thickness of each dielectric half=T_{D}=V_{MAX}/E_{AIR}=(600 V)/(3e6 V/m)=2 e-4 m=0.008 in

Next, calculate the width of the grounded conductor. The width of the grounded conductor is the same as when the two grounded conductor halves are assembled together. Also, this width is equivalent to the width of the inner conductor plus the thickness of both dielectric halves as a flat face is what is desired in the device.

Grounded conductor width=W_{G}=2T_{D}+W_{C}=2*(2 e-4m)+8.128 e-4m=1.2128 e-3 m=0.0478 in

Next, decide the material to be used for the weak dielectric half and the strong dielectric half. Remember to take into consideration their dielectric strengths as well as their permittivities. A smaller dielectric strength than air, will have the material ionizing and causing a short and damaging the device.

Weak dielectric material=Teflon; permittivity=∈_{rW}=2.1

Strong dielectric material=Calcium Copper Titanate; permittivity=∈_{rS}=250000

Next, derive the formula for the lengths of the distance between the a face of the inner conductor to the two grounded conductors. These paths will leave the center of the first face and travel to the to the midpoint of the grounded conductor's outside width. This formula will be used for the next step in deciding the radius of the face.

L_{E}=2*[R_{C}+T_{D}+H_{G}+½W_{G}]=2R_{C}+2T_{D}+2H_{G}+W_{G}

Next, derive the expression to be used in place of the volume charge density, p_{v′}, of the inner conductor. This will go through two phases. The first phase will show that the volume charge density is nothing more than the surface charge density divided by the thickness of the dielectric half multiplied by a factor of two because there are two opposite faces the inner conductor possesses. Next, the surface charge density will be shown to be nothing more than the difference of the electric flux densities, D_{W} and D_{S}, of the weak dielectric and the strong dielectric, respectively. Because the electric flux densities are equal to the absolute permittivity times the electric field and the electric field cannot be greater than the dielectric strength of air, the electric field can be expressed as two times the maximum voltage on the inner conductor divided by the inner conductor's width. This will be shown.

p_{v′}=2*ps/T_{D}

ps=D_{S}−D_{W}=(∈_{rS}−∈_{rW})*∈o*E_{AIR}=(∈_{rS}−∈_{rW})*∈o*[2*V_{MAX}/W_{C}]

p_{v′}=4*V_{MAX}*(∈_{rS}−∈_{rW})*∈o/[W_{C}*T_{D}]

Next, the expression for the volume, v′, for the inner conductor will be shown.

Volume for inner conductor=v′=A_{C}*W_{C}=JI[R_{C}]²*W_{C}

Next, calculate the radius of the inner conductor needed to achieve the desired maximum force. Also calculate the maximum stored energy of the system and the length of the longest path from one point on one face to its corresponding point on the other face. This is done by using the energy and force equations in a substitution solve.

W_{E}=½*p_{v′}*V_{MAX}*v′=½*4*[V_{MAX}]²*(JI*[R_{C}]*W_{C})*(∈_{rS}−∈_{rW})*∈o/[W_{C}*T_{D}]

W_{E}=2*JI*∈o*[V_{MAX}]²*(∈_{rS}−∈_{rW})*[R_{C}]²/T_{D}

Fe=W_{E}/L_{E}=2*JI*∈o*[V_{MAX}]²*(∈_{rS}−∈_{rW})*[R_{C}]²/[T_{D}*L_{E}]

R_{C}=0.07259 m=2.858 in

W_{E}=131.73 N-m=131.73 Joules (J)

L_{E}=0.1975928 m=7.779 in

Next, calculate the capacitance of all electrostatic thrusters moving the object. The energy formula for capacitors can be used here.

W_{E}=½*C_{D}*[V_{MAX}]²

C_{D}=2*W_{E}/[V_{MAX}]²=2*(131.73 J)/(600 V)²=731.8 μF

Total capacitance for all thrusters moving the object in the same direction=C_{V}=I*C_{D}=731.8 μF

(This is important. The electrostatic thruster can only move in one direction, therefore, at least two sets are needed for forward and reverse. All thrusters moving in the same direction are to be wired as parallel connections and, therefore, their capacitances add.)

Next, calculate the electrical resistance, R_{V}, needed to be able to accelerate/decelerate the electrostatic thruster in one second.

τ_{V}=R_{V}*C_{V}

R_{V}=T_{V}/C_{V}=1 s/731.8 μF=1366Ω

Next, calculate the maximum current, I_{MAX}, used by the object. Current is used only when accelerating and decelerating because the electrostatic thrusters are capacitors.

I_{MAX}=V_{MAX}/R_{V}=600V/1366Ω=0.439 A=439 mA

Next, calculate the maximum power, T_{MAX}, used by the object.

T_{MAX}=I_{MAX}*V_{MAX}=0.439 A*600V=263.4 Watts (W)

Next, find the maximum operating time, T_{MAX}, of the electrostatic thruster.

T_{MAX}=u_{V}/P_{MAX}=7.2 kWh/263.4 W=27.3 hours=98280 s

Next, find the average range the electrostatic thruster will operate. This is done by finding the maximum ranges at the lowest speed, u_{LOWEST}, and the highest speed, u_{HIGHEST}, respectively, and averaging the two ranges.

Range_{LOWEST}=u_{LOWEST}*T_{MAX}=2.25 m/s*98280 s=221130 m=137 miles (mi)

Range_{HIGHEST}=u_{HIGHEST}*T_{MAX}=27.0 m/s*98280 s=2653560 m=1649 mi

Range_{AVERAGE}=(Range_{LOWEST}+Range_{HIGHEST})/2=1437345 m=893 mi

From these calculations, the physical dimensions of the electrostatic thruster can be made. These are the following dimensions:

Inner conductor radius: 0.07259 m=2.858 in
Each dielectric half's inner radius: 0.07259 m=2.858 in
Thickness of each dielectric half: 2 e-4 m=0.008 in (This value is also the width of each dielectric half.)
Each dielectric half's outer radius: 0.07279 m=2.866 in
Each grounded conductor's inner radius: 0.07279 m=2.866 in
Height of each grounded conductor: 0.0254 m=1.000 in
Each grounded conductor's outer radius: 0.09819 m=3.866 in
Width of the inner conductor: 8.128 e-4 m=0.032 in
Width of the device: 1.2192 e-3 m=0.048 in (This value is the sum of the width of the inner conductor and both values of the thickness of each dielectric half. This value is also the entire width of the grounded conductor.)

The electrical circuit schematic which includes the electrostatic thruster is shown in FIG. 12. The electrical resistance of the circuit is shown as a variable resistor (10) because it is simple to mechanically change the resistance by linking the variable resistor (10) to the accelerator. Because the electrostatic thruster is basically a large capacitor, a capacitor is shown for the schematic representation for the electrostatic thruster (12).

To assemble an electrostatic thruster, place one dielectric half (2, 3) on one side of the inner conductor (1) and place the second dielectric half (3, 2) on the remaining side of the inner conductor (1). Next, place one grounded conductor half (6) in the device in such a way that its threaded grounded power terminals (7) surround the dielectric tabbed power entries (5) of one the dielectric halves (2, 3). Next, place the remaining grounded conductor half (6) in the device in such a way that its threaded grounded power terminals (7) surround the dielectric tabbed power entries (5) of the remaining dielectric half (3, 2). Finally, insert two coaxial cables onto the device in such a way that each coaxial cable is fully screwed onto a combined threaded grounded power terminal. The inner conductor (1) of the remaining free ends of the coaxial cable are inserted into the same terminal of the variable resistor (10) of the electrical voltage source (11) while the outside shield of the coaxial cable is connected to the chassis or electrical ground (9) of the circuit.

Adjust the resistance of the variable resistor (10) to change the force (8) exerted by the electrostatic thruster.

1. I claim an electrical apparatus including:
a first electrical conductor consisting of a volume with a perimeter of arbitrary polygonal shape,
a first dielectric of a first unique permittivity whose perimeter is a polygonal shape which is the same as that of the first electrical conductor consisting of a volume with a perimeter of arbitrary polygonal shape,
a second dielectric of a second unique permittivity whose perimeter is a polygonal shape which is also the same as that of the first electrical conductor consisting of a volume with a perimeter of arbitrary polygonal shape, and
a second electrical conductor whose inner perimeter is of the same polygonal shape as the outer perimeters of the first dielectric of a first unique permittivity and the second dielectric of a second unique permittivity,
where the said first electrical conductor consisting of a volume with a perimeter of arbitrary polygonal shape has one of its volume's two faces enclosed to an arbitrary depth by the said first dielectric and the said first electrical conductor volume's opposite face is enclosed to a depth left by the said first dielectric by the said second dielectric and where the said first dielectric and the said second dielectric are bordered on their outer perimeters by the said second electrical conductor,
whereby the said electrical apparatus will produce a non-zero force perpendicular to face of the said first electrical conductor whenever the said first electrical conductor has an electrical voltage potential of greater than zero volts.

2. I claim an electrical apparatus including:
a first electrical conductor consisting of a volume with a perimeter of arbitrary polygonal shape,
a first dielectric of a first unique permittivity whose perimeter is a polygonal shape which is the same as that of the first electrical conductor consisting of a volume with a perimeter of arbitrary polygonal shape,
a second dielectric of a second unique permittivity whose perimeter is a polygonal shape which is also the same as that of the first electrical conductor consisting of a volume with a perimeter of arbitrary polygonal shape, and
a pair of second electrical conductors whose inner perimeters are of the same shape as two opposite sides of the outer perimeters of the faces of the first dielectric of a first unique permittivity and the second dielectric of a second unique permittivity,
where the said first electrical conductor consisting of a volume with a perimeter of arbitrary polygonal shape has one of its volume's two faces enclosed to an arbitrary depth by the said first dielectric and the said first electrical conductor volume's opposite face is enclosed to the depth left by the said first dielectric by the said second dielectric and where the said first dielectric and the said second dielectric are bordered on two sides of their outer perimeters by the said pair of second electrical conductors,
whereby the said electrical apparatus will produce a non-zero force perpendicular to face of the said first electrical conductor whenever the said first electrical conductor has an electrical voltage potential of greater than zero volts.
